(19) United States
(12) Patent Application Publication
(10) Pub. No.: US 2024/0051635 A1
(43) Pub. Date: Feb. 15, 2024

(54) SPROCKET ASSEMBLY

(71) Applicant: Super Clean Bike Limited, London (GB)

(72) Inventor: Paul Lancefield, London (GB)

(73) Assignee: Super Clean Bike Limited, London, OT (GB)

(21) Appl. No.: 18/548,795

(22) PCT Filed: Mar. 2, 2022
(86) PCT No.: PCT/GB2022/050547

§ 371 Date: Sep. 1, 2023

(30) Foreign Application Priority Data
Mar. 2, 2021 (GB) 2102918.6
Jun. 3, 2021 (GB) 2107943.9

(51) Int. Cl. B62J 31/00; B05B 12/04; B05B 1/16; B62J 50/16

(52) U.S. Cl. CPC B62J 31/00; B05B 12/04; B05B 1/1645; B62J 50/16

(57) ABSTRACT

A sprocket assembly comprising a mount; and a sprocket having an opening for receiving the mount such that the sprocket can rotate around the mount, the sprocket having a plurality of radially extending fluid pathways extending from the opening to a radially distal edge, wherein the mount includes a manifold for fluid to be supplied to the sprocket, the manifold having a fluid exit channel towards the opening of the sprocket such that each radial pathway in the sprocket is in fluid communication with the manifold over only a part of a rotation of the sprocket about the mount.

### BACKGROUND OF THE INVENTION

The present invention relates to a sprocket assembly through which fluid can be supplied, typically for use when cleaning and/or lubricating the joints of a bicycle chain.

### DESCRIPTION OF PRIOR ART

The means by which a bicycle chain can be cleaned and lubricated has long been a concern for cyclists.

A way of cleaning a bicycle chain, that is widely understood to be one of the most, if not the most effective method, involves removing the chain and placing it in an ultrasonic cleaning device for a period of time. While this is most probably the most effective cleaning method, it is inconvenient to remove the chain, and fast acting ultrasonic cleaning devices remain expensive.

It therefore remains advantageous to be able to clean the chain without first having to remove it from the bicycle. Many devices to help with this task have been invented over the years, with patents relating to the task dating all the way back to 1800's.

One of the more common features of these inventions is the notion of a chain bath containing some form of liquid solvent and brushes where the bath can be applied to the chain while it is still on the bike, and where the chain can be turned by turning the pedal crank arms.

Other devices include nozzle arrangements for spraying the chain and cleaning wands with brushes, where solvent or air can be applied.

The method of bathing the chain in solvent has the disadvantage that the solvent does not always satisfactorily penetrate chain joints and pins and therefore often only cleans the open surfaces. Additionally, it does not wash the joints and pins with sufficient vigour as to remove all contaminants that might be located deeper within the joints and around the pins. Additionally it can be difficult to wash all the solvent out of the joints prior to re-lubricating the chain, which can lead to the lubricant being contaminated with the solvent in the location. This is undesirable as it can affect the lubricating properties of the apply lubricant which should ideally be pure and free from contaminants. Additionally, contaminants that a chain bath can fail to remove will typically include particulate matter, and failing to remove this matter can increasing friction in the chain joints and increasing chain wear. The chain is an extremely important element of the drive chain of a bike and makes a substantial contribution to drive chain energy loss. Indeed, research has shown that differences between brands of chain lubricant can make up to a 10 watt difference in drive chain efficiency. A badly maintained and/or badly contaminated chain can easily result in an even greater degree of energy loss.

### SUMMARY OF THE INVENTION

According to the present invention there is provided a sprocket assembly comprising: a mount; and a sprocket having an opening for receiving the mount such that the sprocket can rotate around the mount, the sprocket having a plurality of radially extending fluid pathways extending from the opening to a radially distal edge, wherein the mount includes a manifold for fluid to be supplied to the sprocket, the manifold having a fluid exit channel towards the opening of the sprocket such that each radial pathway in the sprocket is in fluid communication with the manifold over only a part of a rotation of the sprocket about the mount.

The invention provides a convenient way for a bike owner to apply fluids in a focused manner on the bicycle chain joints and pins—it can be used both for cleaning and/or lubricating and can thereby help ensure both liquid and solid contaminants are substantially displaced from the joint, and/or the joint is properly lubricated. Due to the dedicated fluid pathways that direct the fluid at the joints of the chain links, less fluid is required to obtain desired cleaning. Further, when considering lubrication, the lubricant can be supplied directly to the moving parts of the chain, i.e. the joints of adjacent links and therefore minimises wasted lubricant. The invention can be mounted with a housing that allows the application of the fluid by using just one hand, while the chain is fed through the drive chain by the other hand turning the bicycle pedal crank arms.

The manifold may includes a fluid receiving inlet and a fluid supply may be provided in communication with the inlet. The fluid supply may include one or more of steam, liquid solvent, air and a lubricant.

One or more of the radially extending fluid pathways may widen towards the radially outermost end of the respective pathway.

The sprocket may contain a plurality of teeth extending radially outward and defining valleys therebetween. The teeth may be shaped to engage with a bicycle chain. The radially outermost end of a pathway may be located at the radially innermost point of the valley.

The sprocket may have an elastomeric coating on at least part of its outer surface or its outer surface may be formed from an elastomeric material. The elastomeric material may be on or form part of one or more surfaces that is intended to contact, in use, a chain.

The assembly may further comprise a second rotatably mounted sprocket. The second sprocket may be offset from the first sprocket such that, in use, a chain can pass between, but engage with, both sprockets. The second sprocket may be part of a second sprocket assembly as described above. The axes of rotation of the two sprockets may be parallel. The two sprockets may be relatively movable so as to vary the separation between the sprockets.

At least one of the sprockets may have one or more walls extending radially outwards adjacent the sprocket teeth. One or both of the sprockets may have a pair of walls defining a channel in which the sprocket teeth are located.

Also provided is a chain tool comprising: a sprocket assembly as described above and a housing for retaining the mount of the sprocket assembly.

The tool may further comprise a handle by which the tool can be operated one handed.

The tool may further comprise a source of pressurised fluid.

The tool may further comprise an actuating button to operate the source of pressurised fluid.

The manifold may be selectively positionable within and/or relative to the housing to alter the location of the exit channel.

The tool may further comprise an inlet port in fluid communication with the manifold for receiving an aerosol containing fluid to be supplied.

The inlet port may be angled relative to the axis of rotation of the sprocket.

The inlet port is angled relative to the axis of rotation of the sprocket at between 30 and 70 degrees, more preferably between 40 and 50 degrees and may be at 45 degrees.

The tool may further include a drip tray, which may be integrally formed with the housing which holds the axle, or with any other component, or may be detachably mounted on the housing or other suitable component. The drip tray is positioned such that, in use, the tray can be located below the sprocket to catch fluid that falls off the chain and/or sprocket. The tray preferably contains a recess in which liquid can be retained.

The sprocket of any of the examples may include one or more visual indicators, such as physical markers, that identify the location of one or more teeth of the sprocket. Alternate teeth of the sprocket may have different sizes to match the larger/smaller gaps of adjacent links, where smaller gaps are in “inner” links, and the larger gaps are in the “outer” links, as shown in FIG. 8. The markers may be indicative of one size of sprocket tooth.

The sprocket assembly may be included within, or as part of, a cycle chain joint steam cleaner and/or a lubricating device. The steam cleaner may be distinct from the lubricating device, or the same device may be used for both operations, with suitable cleaning between to prevent cross contamination. One option is for a hand-held steam cleaner which focuses steam on the joints of the chain. A second, utilising the same principle, can be a lubricant applicator. The second device will comprise a sprocket assembly as the steam cleaner, but in one embodiment the axle of the sprocket may be the cap of a can of lubricant, which may be pressurised or non-pressurised, such that the lubricant can be applied focused on the chain links and such that it drives out water from the prior steam cleaning. Also research has shown one major loss of efficiency with regard to cycle drive chains is due to over lubrication of the chain, so preferably the spray nozzle is configured to output a fine aerosolised oil spray with a higher air to oil volume. An air compressor and high tolerance metal nozzle and spray may provide one way to achieve the fine aerosolised oil spray.

A sprocket assembly as described above can be utilised in a bicycle chain steam cleaning device, connected to a steam generator, such that the rotating sprocket substantially focuses steam under pressure on one bicycle chain joint at a time. The steam (which throughout this application is taken to include the standard definition of steam which includes hot air containing condensed water droplets as well as water in its gaseous form) may be generated from pure water, or may additionally include a solvent additive to aid degreasing the chain link joints. A button on the cleaning device may electronically control a steam generator, possibly a valve on the generator, so the user of the device can apply steam as required to the chain. The cleaning device may be connected to the steam generator by a silicone tube (or indeed a tube made of any suitable material). A control cable may also be connected between the cleaning device and the steam generator along which control signals can be passed, although wireless passing on signals may also be used. The cleaning and/or lubricating device beneficially allows the device to be conveniently positioned by the user on the chain and control the device with one hand, whilst the other hand is free to rotate the pedal crank arms of the bicycle, so the chain can be turned and its full length cleaned. The sprocket assembly allows efficient “in service” cleaning and/or lubrication, that is cleaning and/or lubrication whilst the chain is in place on a bicycle, as removal of the chain is a process that is not always easy to do nor is a task that many bicycle owners would feel comfortable doing. As such, the invention permits a regular bicycle owner to obtain a better, more professional clean and/or lubrication of the chain with little increase in effort and without requiring significant knowledge of bicycle mechanics.

Some commercially available aerosol surfactant products such as WD40 have solvent or diluent characteristics in relation to typical bicycle chain lubricants. Additionally, aerosol can propellants can are typically formulated such that they are comprised of one or more hydrocarbons such as Butane, Propane or Hexane and, in relation to the lubricants found on bike chains, typically also have solvent or diluent characteristics. Aerosol propellants are also volatile which aids solvent and/or diluent efficacy. But the high volatility and low boiling points of typical aerosol propellants leads to rapid evaporation such that under usual spray conditions and distances, i.e. when used without the described cleaning device, the propellant turns to gas and does not play a significant role in the dissolution or dilution of the dirty or contaminated bicycle chain lubricant the device is intended to help remove and/or replace. The claimed invention, by channeling the propellant into the bicycle chain links, ensures the high volatility propellant in addition to the product dissolves into the contaminated or dirty bike chain lubricant such that the solvent and diluent action of the propelled fluid is considerably enhanced.

The steam generator may also be utilised with a supply of lubricant. Alternatively, a different pressure supply may be provided, that may just be pressurised air to mix with the lubricant. In any example where a pressurised fluid is used, the pressure of the fluid supplied via the sprocket assembly acts to blast away debris and/or drive lubricant or steam into the joints of the chain to effect deeper cleaning/lubrication that can be achieved by mere rubbing or brushing across the chain.

The sprocket may, in its axial direction, be at least as wide as the chain to be cleaned, that is when measuring across the inner and outer chain side plates. Exit channel(s) is/are either above the points at which the chain inner and outer sides plates are adjacent to each other or there may be an outer flange on the sprocket effectively directing fluid through the inner and outer chain side plates.

### BRIEF DESCRIPTION OF THE FIGURES

The present invention will now be described by way of example with reference to the accompanying drawings. In the drawings:

FIG. 1 shows a first steam cleaning device;

FIG. 2 shows a close up view of the device in FIG. 1;

FIG. 3 shows an expanded view of the components in the device in FIG. 2;

FIG. 4 shows the steam delivery side panel from multiple angles;

FIG. 5 shows the sprocket axle from multiple angles;

FIG. 6 shows the device being used on a bicycle chain in the correct orientation;

FIG. 7 shows the device sprocket on a bicycle chain and the direction steam is applied via the sprocket;

FIG. 8 shows an isometric view of the device sprocket on a bicycle chain;

FIG. 9a shows a section view of the device sprocket on a bicycle chain;

FIG. 9b shows a second section view of the device sprocket on a bicycle chain;

FIG. 10 shows a second embodiment of the device, this time with two sprockets, from two different angles;

FIG. 11 shows and expanded view of the second embodiment of the device;

FIG. 12 shows a section view of the second embodiment of the device;

FIG. 13 shows a second embodiment of the sprocket used in the second embodiment of the device;

FIG. 14 shows a third embodiment of the device used for the application of lubricant or cleaning solvent from a spray can;

FIG. 15 shows an isometric view of the third embodiment;

FIG. 16 shows an expanded view of the components of the third embodiment;

FIG. 17 shows a section view of the third embodiment; and

FIG. 18 shows a section view of the sprocket design used in the third embodiment where each radial fluid escape channel divides into two;

FIG. 19 shows a fourth embodiment of the device where the spray can applicator is push button activated and has an integrated splash and drip tray;

FIG. 20 shows an expanded view of the fourth embodiment of the device from a side view and an isometric view;

FIG. 21 shows a side view and rear view and a section view of the aerosol can cap and the sprocket axle button parts of the fourth embodiment of the device;

FIG. 22 shows the aerosol cap part of the fourth embodiment of the device from above and from below;

FIG. 23 shows an additional embodiment of the elastomer sprocket previously described;

FIG. 24 shows a fifth embodiment of the of the device 501 with a design suitable for plastic injection moulding;

FIG. 25 shows an expanded view of the parts of the fifth embodiment;

FIG. 26 shows an expanded view of the push button assembly adapted to be suitable for plastic injection moulding;

FIG. 27 shows the fluid entry part, a hose part and fluid exit part that form a subset of the parts in the push button assembly;

FIG. 28 shows the fluid exit part and the hard sprocket part;

FIG. 29 details the fluid exit part from a number of different angles;

FIG. 30 shows a sixth embodiment where the sprocket axle is integrated with the main cap;

FIG. 31 shows the button assembly of the sixth embodiment, where the button is separate from the axle;

FIG. 32 shows just the button of the sixth embodiment.

### DETAILED DESCRIPTION

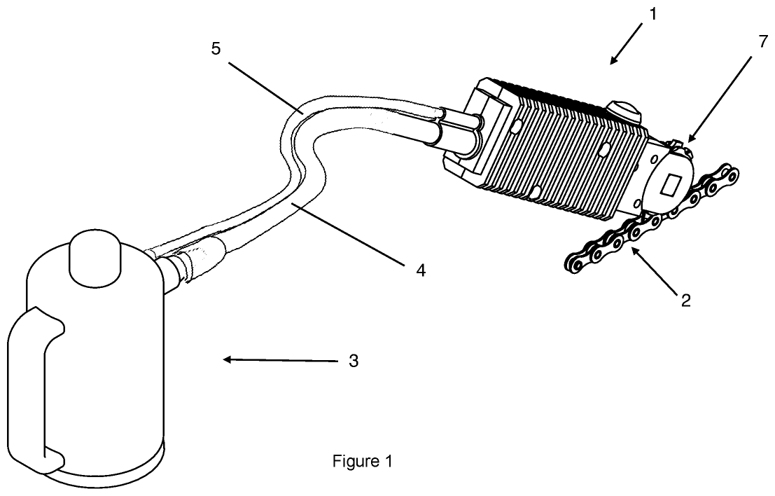

FIG. 1 shows a steam cleaning device 1, incorporating a sprocket assembly as will be described later, therein. The device can be positioned on a portion of chain 2 with the device connected to a small portable steam generator 3 by means of a silicon steam delivery tube 4 and an electrical control cable 5. Movement of the device 1 along the chain causes a sprocket 7 (described in more detail with reference to later figures) to rotate which will permit fluid, in this case steam and optionally a solvent/degreaser, to be dispensed onto the chain in order to effect cleaning of the chain and specifically the joints between adjacent links.

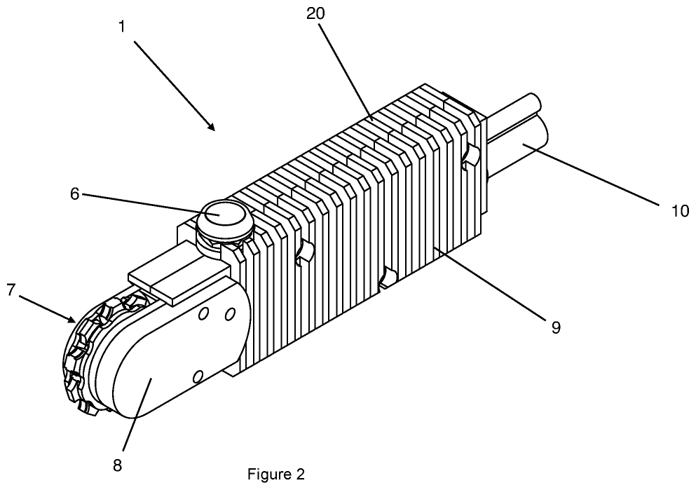

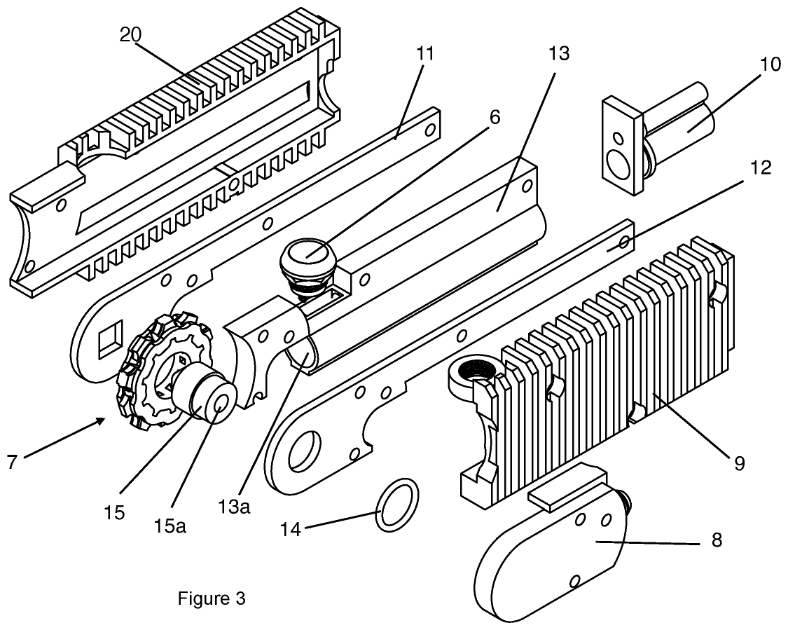

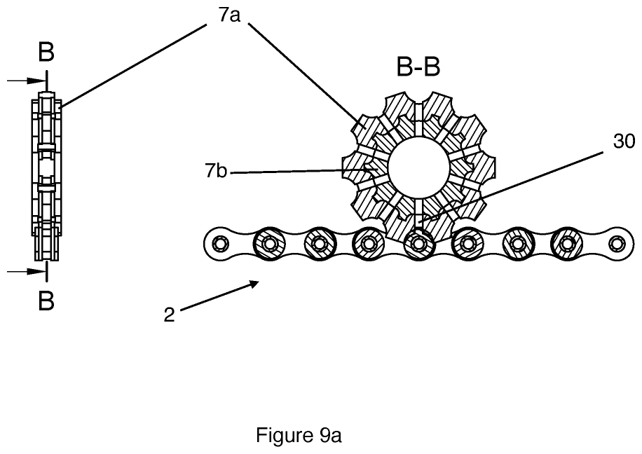

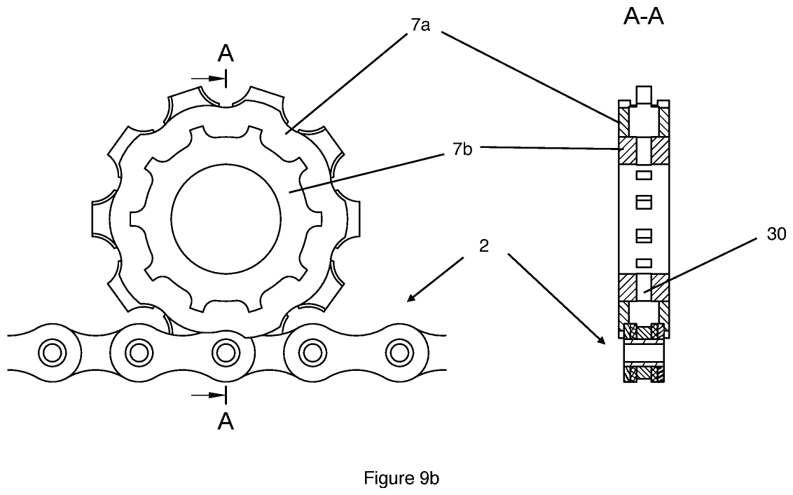

FIG. 2 shows the device 1 closer up. The device 1 comprises a handle section formed in this example by a two part casing 9, 20, each having one or more ribbed sections. The device further comprises a steam delivery panel 8 connected to the handle and sprocket 7 which is rotatably mounted within a sprocket assembly (described in more detail in FIG. 3). Steam is supplied from the steam generator into the steam delivery panel and then into the sprocket assembly. The outer surface of at least part of the sprocket 7 may be made of a heat resistant elastomer such as silicone or a heat resistant flexible polymer, where between each tooth of the sprocket there are fluid pathways or exit channels—in a radial arrangement (a detailed view can be seen in FIG. 9a). The hub part of the sprocket where steam enters, one at a time, the radial holes, is typically made of a metal; a material with a higher heat deflection temperature. The teeth on this sprocket are shaped to engage closely with the three-dimensional profile of a typical bicycle chain. Typically, the sprocket provides an inverse match to the profile of a specific make and brand of bicycle chain such that it fits snugly over the chain as it is rolled along it. The device handle is comprised of a ribbed casing 9 and 20. The ribbed design helps minimise heat transfer to the user's hand from steam passing through the core of the device, though other mean of insulating the user's hand from excessive heat could be used. The device can be run along the chain by the user, such that the sprocket, engaged with the chain, rotates.

Steam is dispensed by pushing a button 6, which electronically operates a valve in the steam generator (typically this would be a solenoid valve). The user can thus dispense steam through an exit channel 30 (see FIG. 9a) in the sprocket down towards the chain. As the sprocket rotates and one of the several exit channels in the sprocket lines up with an exit channel in the axle about which the sprocket rotates, steam is released under pressure to one chain link joint at a time. At the rear of the device there is a strain relief sleeve feature, 10, that would typically be constructed of silicone elastomer or a heat resistant TPU and helps prevent kinking and wear damage of the silicone tube connected between the device and the steam generator and also helps bend damage to the electrical control cable.

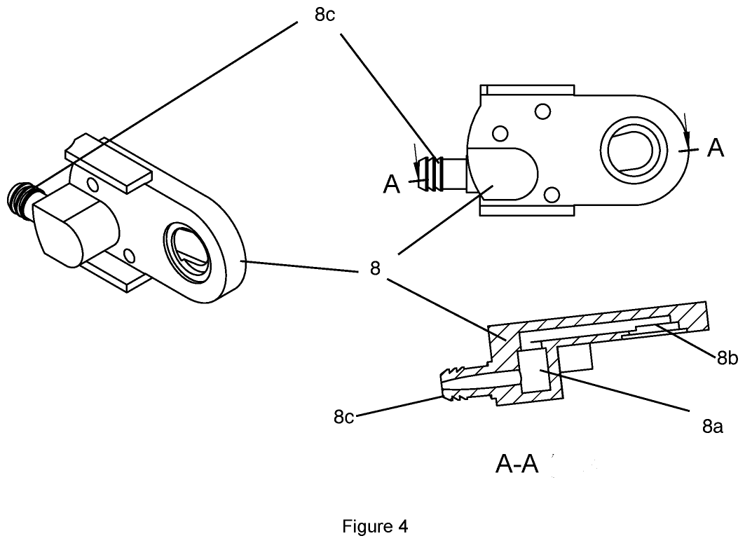

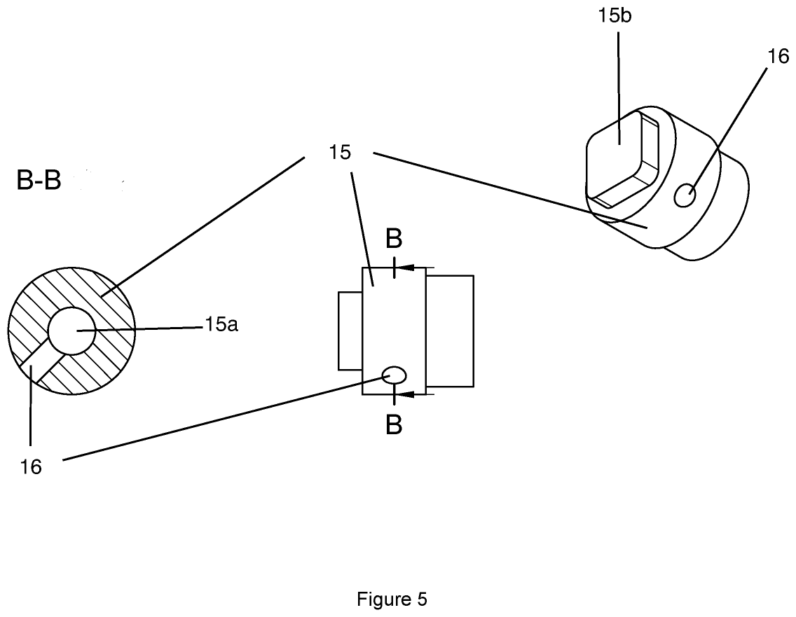

FIG. 3 shows an expanded view of the parts in the device shown in FIG. 2. The device ribbed casing is in two halves—a left side part 9 and a right side part 20. The silicone tube and electrical wire connecting the device to the steam generator is not shown in this diagram. The silicone tube would come into the device via the strain relief sleeve 10 at the rear of the device, through a passageway 13a central plastic core 13. The silicone tube is fitted to the steam delivery panel 8, which routes the steam to a static axle or mount 15 on which the sprocket 7. The combination of the axle/mount 15 and the sprocket is a sprocket assembly. This axle contains central recess 15a which receives the steam or other fluid. This recess acts as a manifold. An exit channel 16 (see FIG. 5) through which the steam will pass connects the manifold to a hole on the radially outer part of the axle 15. The steam will then, when lined up with one of the radial exit channels 30 in the sprocket 7, pass through a channel 30 to be directed towards the bicycle chain. As the sprocket rotates, different channels 30 become aligned. The rotation of the sprocket sequentially opens and closes channels 30 such that the fluid be supplied typically passes through only one channel at any given time. A silicone O-Ring 14 forms a seal between the steam delivery panel and the axle of the sprocket. Elongate fork prongs 11, 12 hold the sprocket and axle and are typically metallic. The axle is provided with a square projection 15b (see FIG. 5) such that the axle 15 remains in a fixed position relative to prong 11 in which it is located and does not rotate. The exit channel 16 (see FIG. 5) therefore also is in a fixed orientation relative to the device 1. For optimum operation, the exit channel should be directed directly toward the chain being cleaned/lubricated so the position in which the user holds the device is important. The position of the axle however may be altered, and thereby altering the orientation of the exit channel 16. This could be beneficial to allow a user to customise the angle at which the device is held. This could be done by either rotating the axle by 90 degrees (for this square end 15b) or by a suitable alternative angle such as 15, 30 or 60 degrees which could be made selectable by using a different shaped projection 15b or by utilising an alternative axle with the radially oriented exit channel at a different angle. Alternatively, some form of releasable locking mechanism could selectively lock and release the axle 15 relative to prong 11, thereby allowing greater user flexibility. A visual indicator may be applied on the projection 15b to identify the orientation of the exit channel 16 and therefore the optimum angle at which the device should be held relative to the chain. The sprocket rotates around the axle 15. At the rear of the steam delivery panel, there is a barbed tube 8c (mostly obscured in this diagram, but shown more clearly in FIG. 4). The silicone steam delivery tube is pushed over this barbed connector and secured with a metal spring hose clip (not shown).

The left and right side of the outer case, the prongs, and side panel are secured together and secure the other component parts, with bolts and nuts (not shown).

FIG. 4 shows the steam delivery side panel 8 from multiple viewing angles which is responsible for routing the steam from the silicone tube to the sprocket assembly axle 15. A cut through view is provided showing the channel 8a through which the steam passes, exiting via an opening 8b which aligns with the manifold 15a in the axle 15.

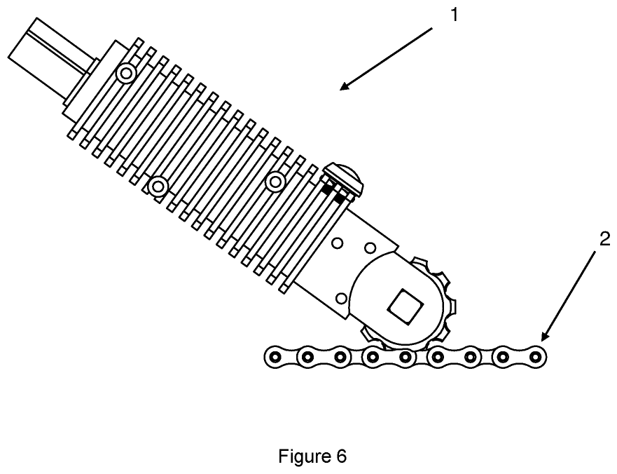

FIG. 5 shows the axle 15 in section view, directly as oriented when looking at the front of the device and in an isometric view. The axle has a manifold 15a, into which steam is fed via the steam delivery side panel. It also has a radial steam exit channel 16 which points downwards when the device is held at a 45 degree angle over the chain (see FIG. 6 for an example of the device in this orientation). This exit channel 16 enables the steam to be applied downwards through a sprocket exit channel 30 as it comes into line below the axle sprocket exit channel 16 in turn as the sprocket rotates.

FIG. 6 shows the device 1 at the angle it would typically be used on the chain by the user. Held in this orientation, the steam exit channel 16 in the axle 15 is pointing directly downwards such that steam is applied through the exit channel 16, to a channel 30 (see FIG. 9a) in the sprocket, and thereby to the chain joint directly below the centre of the axle 15.

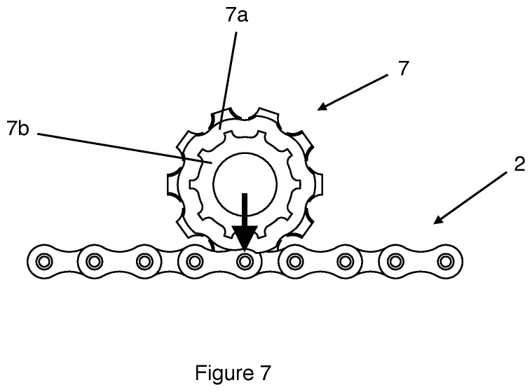

FIG. 7 shows the sprocket engaged with a bicycle chain. The outer sprocket surface 7a of the sprocket 7 which may engage with the chain side plates is preferably made from silicone or a heat resistant flexible polymer or other suitable elastomer. The profile of the sprocket surface 7a has a series of teeth and is designed to minimise steam escaping out the sides and helps ensure the most direct escape route for the steam is via the chain joint currently beneath the radial sprocket exit channel 30 (see FIG. 9) between the sprocket teeth and directly below the steam exit channel in the axle. This might be due to the use of appropriately close machining tolerances between the axle 15 and the surface of the inner sprocket hub 7b of the sprocket. The elastomeric surface of the sprocket may also assist in creating a seal between the end of the sprocket exit channel(s) 30 (see FIG. 9) and the chain joint adjacent to the channel.

As the device is moved along the chain (which may be enabled by the user rotating the bicycle's crank arms) the sprocket 7 rotates, and one exit channel 30 at a time is positioned over/in fluid communication with the exit channel 16 in the axle 15. In this way, when the button is pressed and steam released, the steam will substantially flow via the sprocket exit channel 30 aligned with the axle exit channel 16 (direction indicated by the arrow on the diagram). In the preferred embodiment, the inner sprocket hub 7b is metal. This is preferred for two main reasons. The first is to ensure thermal energy transfer to the material defining the steam path does not exceed the heat distortion temperature of the inner part. As the radial sprocket exit channel rotates past the axle steam exit channel, there will be a moment when the exit channel via which the steam passes will be restricted. This will result in increased rate of flow of the heated air and water, which will in turn result in increased heat transfer. It is therefore preferable the inner face of the sprocket, where the restriction will be highest, is made of a material with a high heat distortion temperature. Secondly, to minimise steam pressure loss the clearance tolerance allowing rotation of the sprocket on the axle will need to be minimal. A metal inner surface will allow for higher tolerances to be used.

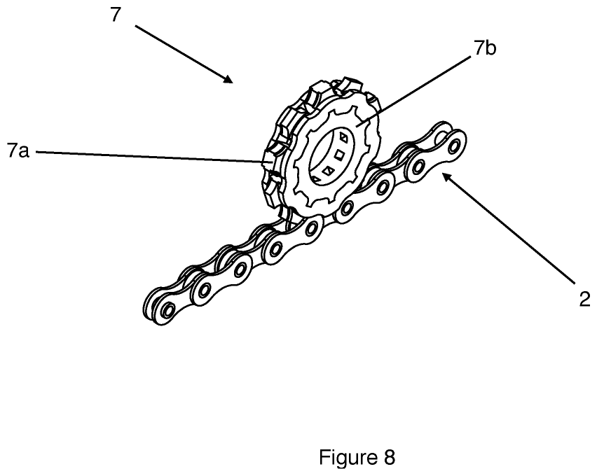

FIG. 8 shows the sprocket on a chain in isometric view. This diagram is provided to aid understanding of the radial exit channels leading from the inside wall of the sprocket to the outside wall between the sprocket teeth.

FIG. 9a shows a section view through the sprocket. Ten radial fluid escape channels can be seen, one of which 30, is oriented such that it will direct fluid downwards onto a link in the chain.

FIG. 9b shows a second section view through the sprocket. Here one of the escape channels 30 can be seen passing through the inner sprocket hub 7b and the outer sprocket surface 7a. It widens such that the channel extends across the interface between the chain side plates. This slot design ensures an escape path for steam pressure relief can be found that runs between plates and joints of the chain link. When the user pushes down on the device such that it substantially forms a seal against the upper surface of the chain, steam is more reliably forced between the chain links.

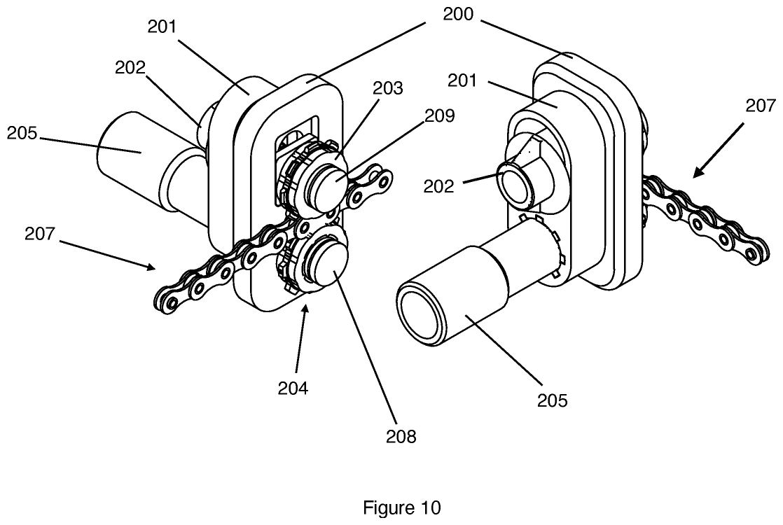

FIG. 10 shows a second embodiment of the chain steam cleaning device, in this case a two sprocket chain cleaning device, in two different isometric views. In this embodiment there are two sprockets. An adjustable sprocket 203 which can be moved away from and towards a second steam sprocket assembly 204, which is similar in form to the sprocket assembly described in the first embodiment. The adjustable sprocket is moved away from the steam sprocket so that the device can be located by the user on the chain 207, the adjustable sprocket can be moved towards the chain and fixed in that position by means of a wing nut 202 attached to an axle 209, such that the chain is sandwiched between the adjustable sprocket and the steam sprocket.

The adjustable sprocket 203 is comprised of a heat resistant elastomer such as Silicone rubber and, unlike the steam sprocket, does not have any fluid escape channels.

A steam supply adapter tube 205 supplies steam under pressure from a steam generator (as previously illustrated in FIG. 1) into the steam sprocket axle 208. The axle 208 contains a similar manifold and exit channel arrangement as in the first embodiment. The sprockets and axles are located within a frame 200. The adapter tube is connected by means of a thread to the steam sprocket axle and a spacer unit 201 fitted over the adapter tube is also fixed in position by the wing nut and adjustment sprocket axle. This spacer unit has a splined design which locks with splines on the adapter tube preventing the adapter tube from rotating in relation to the frame as the device is used.

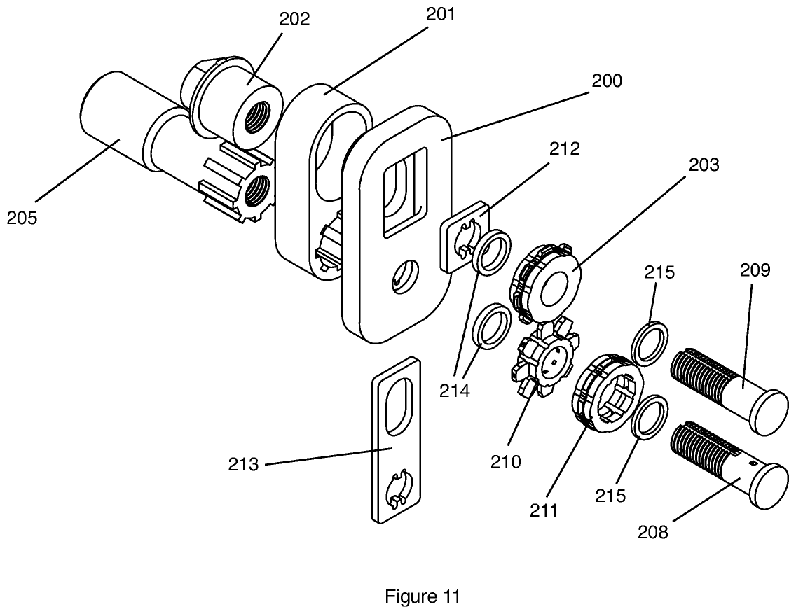

FIG. 11 shows an expanded view of the parts of the two sprocket chain cleaning device such that some additional parts present in the assembly are more clearly visible. A metal axle locator plate 212 is visible, and this plate allows the adjustment sprocket axle to be moved but ensures when the wing nut is done up, the axle will not be able to rotate. The plate has two tabs which locate in slots in the adjustment sprocket axle and which serve to prevent the axle's rotation. A metal core 213 located inside the frame 200 when assembled, provides rigidity to the device.

For the purposes of illustration, the steam sprocket 204 constituent parts 210 and 211 are shown. Typically these would not be seen by the user separated as shown in the diagram, because an outer silicone bumper sleeve 211 would be applied to the metal sprocket core 210 during manufacture, typically by a process known as over-moulding. A two-part composite sprocket and the steam sprocket assembly, comprising the steam sprocket axle 208 and the steam sprocket 204, may be substantially identical to that of FIG. 1, in that the axle 208 has a manifold for receiving steam/fluid, and a fluid exit channel from the manifold to the radial outer edge of the axle, which then aligns with fluid pathways in the sprocket.

Spacer/washers 214 and 215 can also be seen. Additionally in this view it can be seen the adjustment sprocket axle 209 and the steam sprocket axle 208 are both slotted along their length such that when fitted through the metal locator plate and metal core respectively they will not be rotatable in relation to the frame.

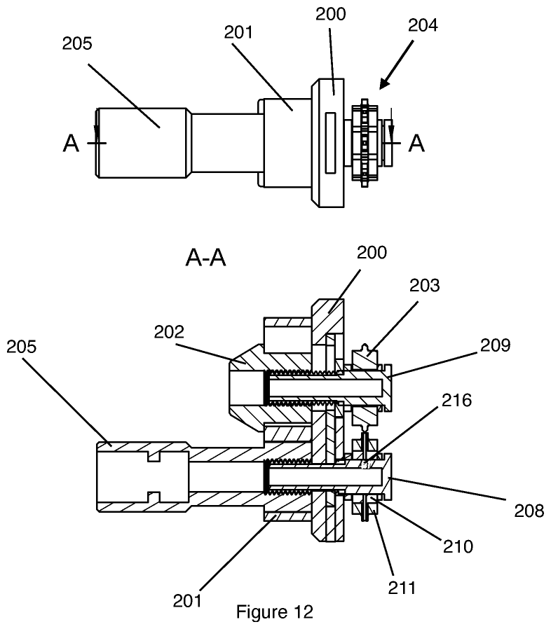

FIG. 12 provides a bottom view and a section view of the two sprocket chain cleaning device with parts previously described. The section view additionally shows the steam sprocket axle escape channel 216 allowing chain to escape in the direction of the adjustable sprocket 203.

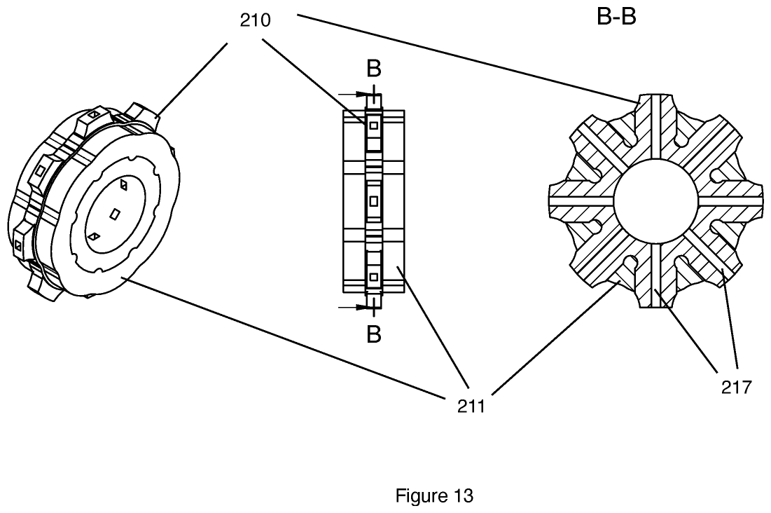

FIG. 13 shows the sprocket with a composite metal central part 210 and elastomer sprocket bumper 211 in an isometric view, front view and side section view. The section view shows the steam escape channels radially arranged through the sprocket, two of which are pointed out by reference label 217. It can be seen that in this example of a two sprocket embodiment of the device, the escape channels run along the centre of each tooth of the sprocket, with the exit hole at the tip of the tooth. This ensures steam is delivered to the gap between chain links and when the chain is sandwiched between the top and bottom sprockets, the exit route for the steam is substantially via the adjacent chain links, helping to clean the inner surfaces of those links. In an alternative, the channels may run to the valleys between the teeth.

Whilst both first and second embodiments are described with reference to being cleaning devices, they could equally be used for supplying lubricant under pressure.

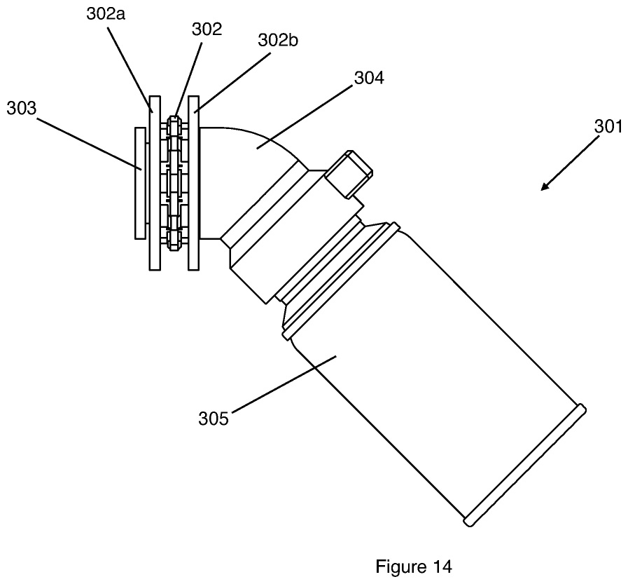

FIG. 14 shows a chain lubricating and/or cleaning device 301, consisting of an elastomer sprocket 302 with two circular flanges 302a, 302b flanking the sprocket teeth, a central axle 303 about which the sprocket turns and a spray can cap 304 connected to the lubrication and propellant exit pipe of a spray can of lubricant or cleaning fluid (such as a solvent) 305. The flanges 302a, 302b help ensure any fluid that may escape from between the sprocket and the axle that does not exit via the exit channels in the sprocket itself, does not come into contact with the chain. This arrangement helps ensure all fluid applied to the chain is done so at points concentrating on the chain joints. The flanges are radially extending walls and extend in this example about the entire circumference of the bumper, although an alternative configuration might be possible, including extending only around a part of the circumference. This may be required should the flanges be mounted such that they were not part of the sprocket but were mounted on the main body of the device 301, such that the sprocket rotated relative to the flanges.

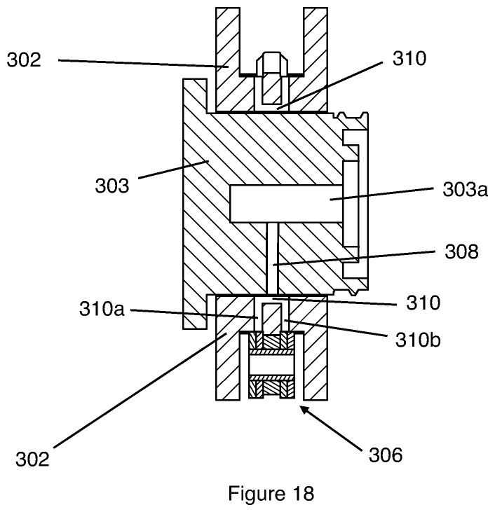

The sprocket assembly, comprising the sprocket axle 303 and the sprocket 302, may be substantially identical to that of FIG. 1, in that the axle 303 has a manifold 303a for receiving lubricant, and a fluid exit channel 308 from the manifold to the radial outer edge of the axle 303, which then aligns with fluid pathways 310 (see FIG. 18) in the sprocket 302. The fluid exit channels are typically 0.05-0.6 mm in diameter. For devices intended for cleaning, and using the commercially available industrial aerosol solvent TF-90 as a point of reference, it has been found that a diameter of greater than 0.4 mm is preferable, with 0.5 mm being a preferred value. For devices intended for lubricating, using the commercially available general purpose aerosol lubricant GT-85 as a point of reference, it has been found that a smaller diameter is preferred, typically of less than 0.25 mm is preferable, with 0.2 mm being a preferred value. A smaller diameter is beneficial when the viscosity of the liquid being expelled is lower.

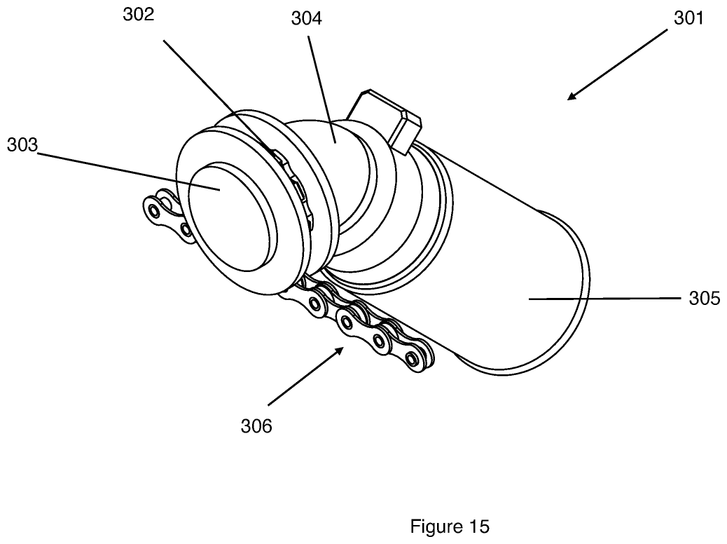

FIG. 15 shows the same chain lubricating and/or cleaning device in isometric view and positioned on a chain 306 as it would be when being used to lubricate and/or clean the chain.

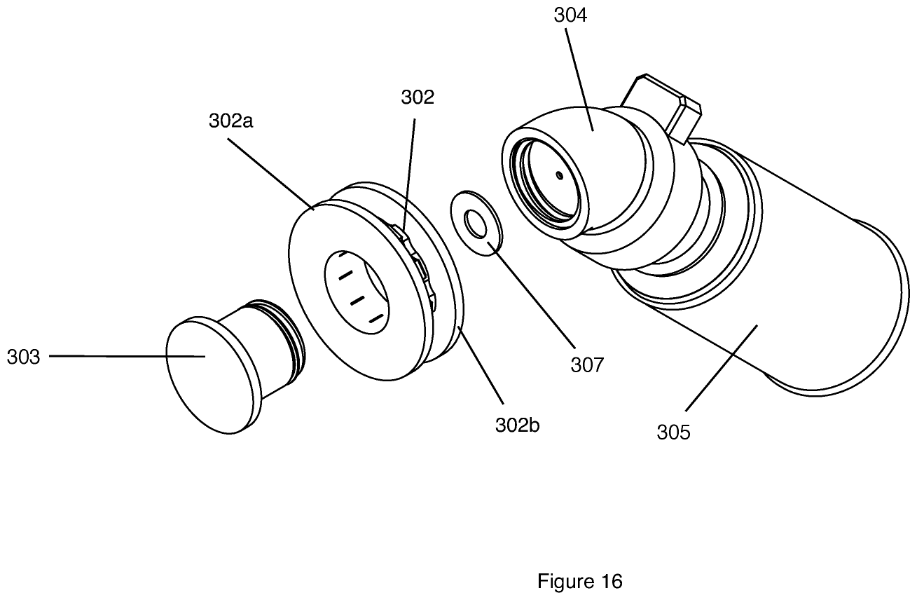

FIG. 16 shows the same chain lubricating and/or cleaning device in an expanded view. In addition to the parts already described, a washer 307 can be seen which provides a seal between the axle and the spray can cap when the axle is screwed in to the cap.

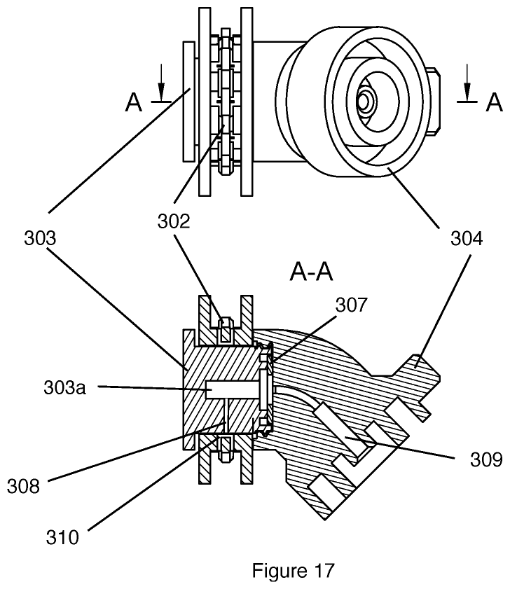

FIG. 17 shows a bottom view and a section view of the spray cap assembly. The spray supply tube 309 supplying lubricant and/or cleaning fluid from the can to the sprocket axle 303. The can would be attached to the bottom of the tube 309 and the axis of the can is at 45 degrees to the axis of the axle. This change in angle between the axis of the can and the axis of the axle ensures the spray can supplies lubricant and/or cleaning fluid from a position lower than centre line of the axle so preserving a substantially upright orientation of the spray can required to ensure the proper operation of the spray can. The supply tube supplies lubricant and/or cleaning fluid to a manifold 303a in the axle 303. A sprocket axle escape channel 308 oriented radially in a downward direction can also be seen.

FIG. 18 shows the elastomer sprocket 302, axle 303 and chain 306 in section view. The section view shows that the radial fluid escape channels 310 in the sprocket are a single slot shape on the inside hole surface of the sprocket, and divide into two separate channels 310a and 310b feeding to the outside surface of the sprocket. These two channels exit the sprocket at a point that when the sprocket used on a chain 306, is directly over the side plates on either side of the chain link, thereby ensuring lubricant and/or cleaning fluid is delivered directly to the chain link. The radial fluid escape channels 310 may have a cross section of 0.2×1.5 mm.

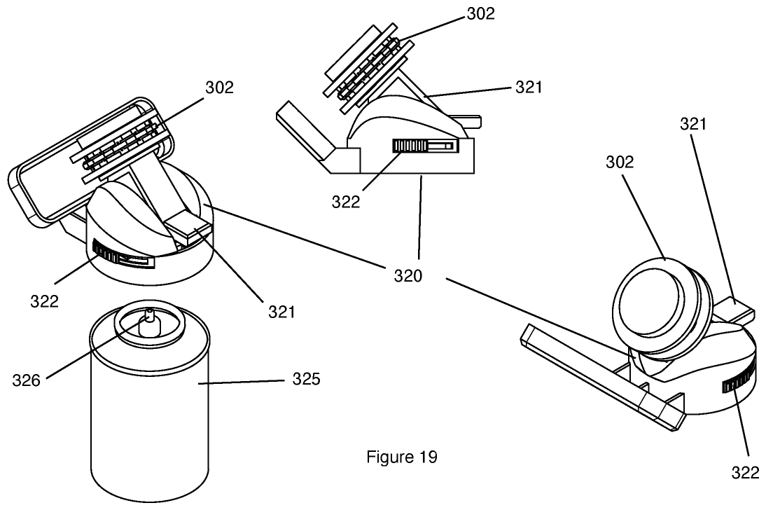

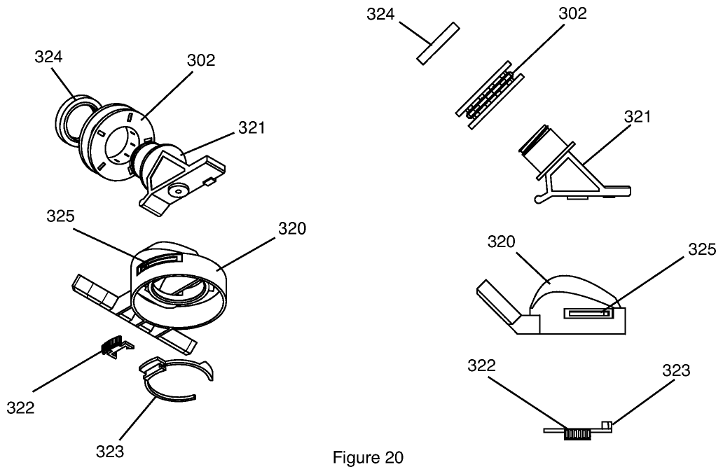

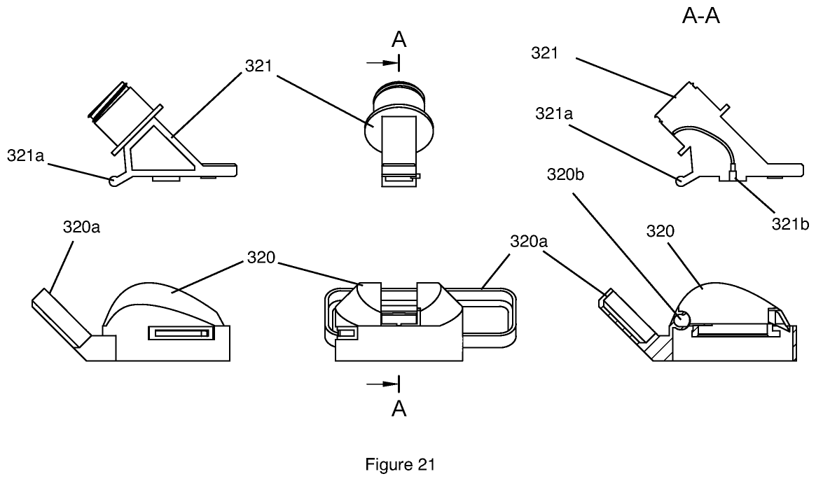

FIG. 19 shows a fourth embodiment of the device, in which a cap 320 has a friction mating fit with the top of the aerosol can 325. A push button sprocket axle 321 is mounted on the cap 320 such that, when pressed, fluid is released from the can. The push button sprocket has an orifice (shown in FIG. 21) which is mated to the fluid escape tube 326 at the top of the can. A sliding button 322 facilitates the operation of a locking mechanism (see 323 in FIG. 20) for preventing accidental activation of the release button.

FIG. 20 shows an expanded view of the assembly described in FIG. 19. In this view, it can be seen there is a lock ring 323 and a clip on button 322, which during assembly is inserted through a slot 325 in an outer wall of the cap 320. The user of the device can slide the button to rotate a raised section of the clip into a position under the push button sprocket axle, to prevent accidental dispensing of the fluid from the aerosol can. The sprocket 302 is retained on the push button sprocket axle 321 by a screw on axle cap 324.

FIG. 21 shows just the cap and the push button sprocket axle in side rear and section views. A drip tray 320a is integrated into the cap so that when the device is in use, fluid from the aerosol which passes through the axle 321 into sprocket 302 and ultimately is expelled via exit channels 308 onto a chain, is substantially prevented from dripping below the device. This helps ensure solvent and/or oil does not get onto surfaces it is not intended for, such as the rear wheel rim or the wall of the rear wheel tyre. In the section view, it can be seen there is a recess 320b in the cap. A projection 321a on the push button sprocket axle, typically having a partially cylindrical end, is snap fitted into place within this recess. There is an entry orifice 321b into which the fluid exit valve of the can is pressed. The orifice is tapered such that it is a smaller diameter at the top than at the bottom. The taper ensures there is sufficient seal between the exit tube and the entry orifice to ensure during operation fluid propelled from the can does not exit at this point. This part then acts as a fulcrum about which the push button cap itself rotates allowing movement of the cap to depress the aerosol nozzle of the can, thus dispensing fluid from the aerosol can. When the button is operated, it's movement, rotating about this fulcrum, describes an arc. The fluid exit tube of an aerosol can is conventionally made of plastic and has sufficient flex to accommodate the movement of the button through the arc as it is pressed, without compromising the seal between the entry orifice 321b and the fluid exit valve of the can.

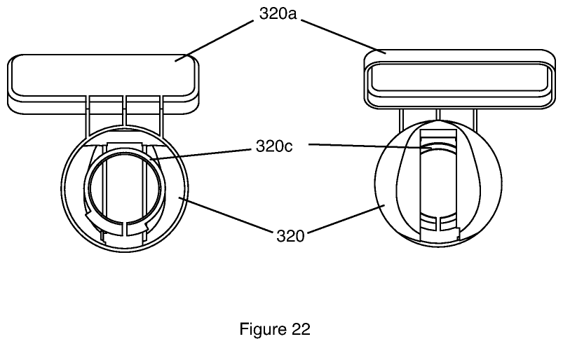

FIG. 22 provides another view of the cap showing the retaining clip 320c which allows the friction mating of the cap to the top ring of the aerosol can.

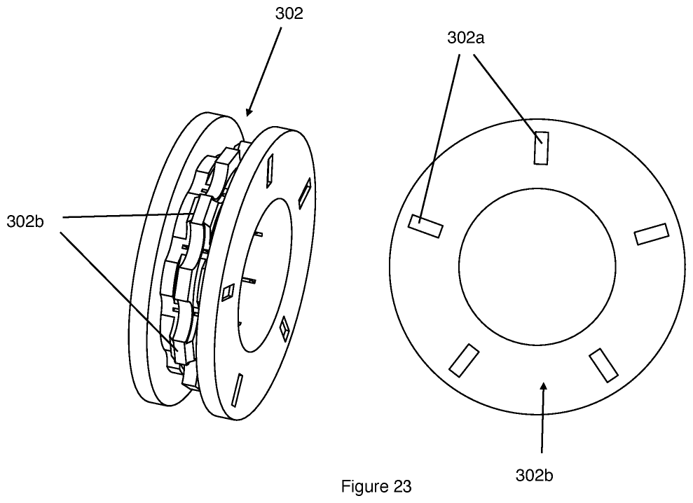

FIG. 23 shows an additional embodiment of the elastomer sprocket 302 previously described. For clarity the sprocket exit channels have not been indicated on this diagram. The elastomer sprocket has, in this embodiment, 5 indicators 302a on the outside wall of the sprocket. The purpose of these indicators is to help the user ensure the sprocket has the correct engagement with the bicycle chain. It can be seen in FIG. 8 that a standard bicycle chain has inner and outer chain links, such that the sprocket, designed to closely engage with the chain links, has alternating wide sprocket teeth 302b and narrow sprocket teeth. When the sprocket is positioned by the user such that an indicator is at the top, a wide sprocket tooth will be diametrically opposite the indicator at the bottom. The indicator allows the user to more easily ensure the wide tooth of the sprocket is inserted into an outer chain link.

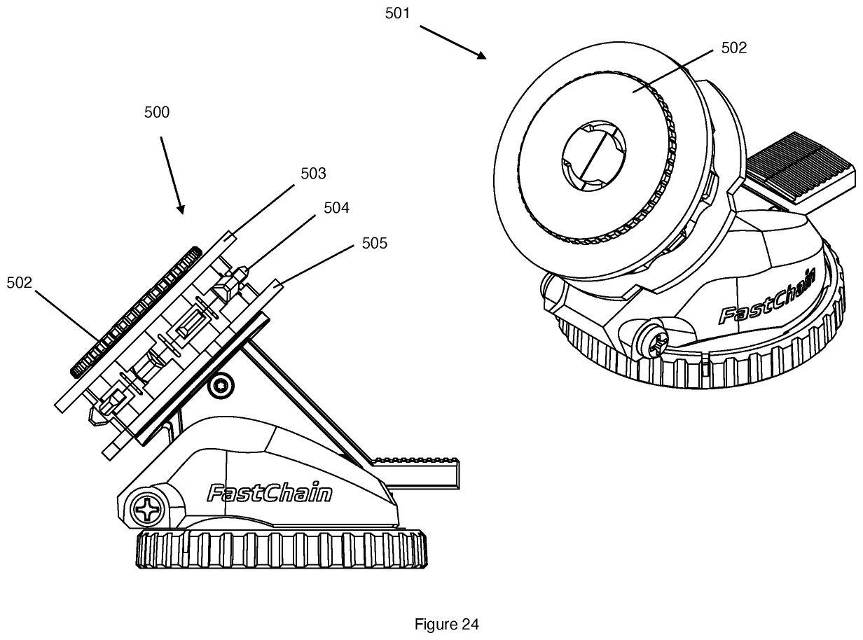

FIG. 24 shows a fully assembled fifth embodiment of the device with a design which may be more suitable for plastic injection moulding. For this design, the sprocket is made of three parts. Outer parts 503 and 505 may be elastomeric and an inner harder part 504, which may be made of a solid material such as a hard plastic or metal. In this diagram, only the sprocket teeth of the hard inner part are visible as they protrude through parts 503 and 505; an arrangement that illustrates this in more detail is in the diagrams that follow. The sprocket is secured in place by a twist fit axle cap 502.

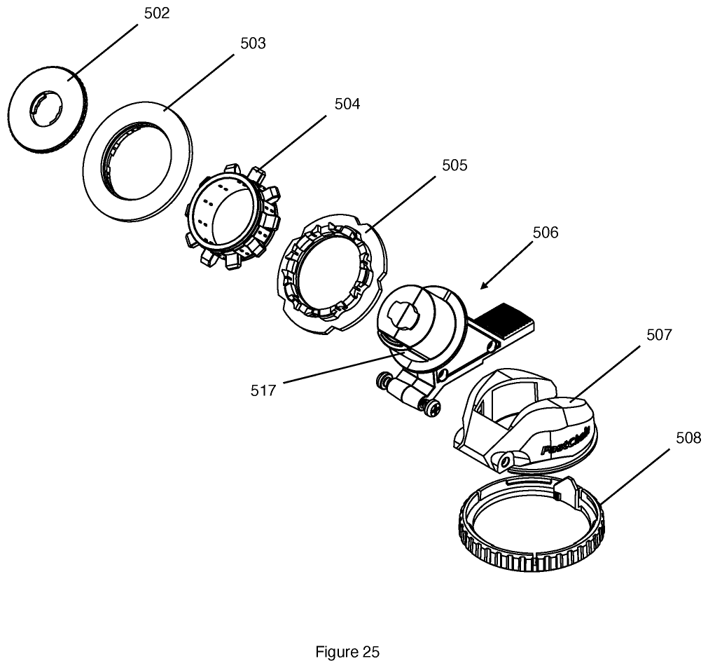

FIG. 25 shows an expanded view of the parts which make up the fifth embodiment assembly. The figure illustrates the twist fit axle cap 502, a first half of the outer elastomeric jacket of the sprocket 503, the hard core of the sprocket 504 which in similar to earlier embodiments of the sprocket such as 302 and which contains pairs of radial holes, a second half of the outer elastomeric jacket of the sprocket 505, a button axle assembly 506, a main cap 507, which is the equivalent of part 320 in the fourth embodiment, and provides a friction fit coupling with the aerosol can. Lastly a lock-ring part 508 is shown. The lock-ring part can be rotated to a position, referred to as the closed position, which blocks the depression of the button. This is useful for preventing accidental discharge when, for example, the device is being transported in a bag whilst still attached the aerosol can. When the lock ring is in the open position, the button can be depressed and aerosol fluid flow activated. Additionally a fluid exit part 517, within the button assembly is indicated. This part forms a lower portion of the radial axle surface about which the sprocket rotates.

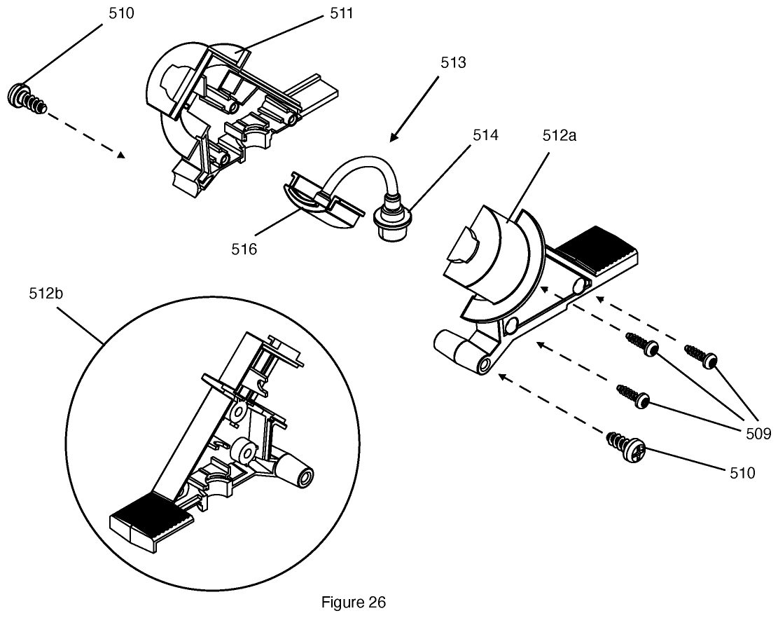

FIG. 26 shows an expanded view of the button assembly 506. The button manufactured by injection moulding is comprised of two halves 511 and 512a (512b showing the same part as 512a but from a different angle). In this expanded view the fluid exit part previously described in FIG. 25 can be seen to be part of a hose assembly 513 that is housed between the two button parts and has the function of transporting the fluid from the aerosol can connected to end 514 to the a fluid exit part 516. To enable the button assembly geometry to have been produced by plastic injection moulding, the part has been split into two halves 511 and 512a. This means additional steps need to be made to ensure there is a sealed conduit for transporting the fluid from aerosol can to the axle. The fluid entry part, hose and fluid exit part design provide such a sealed conduit.

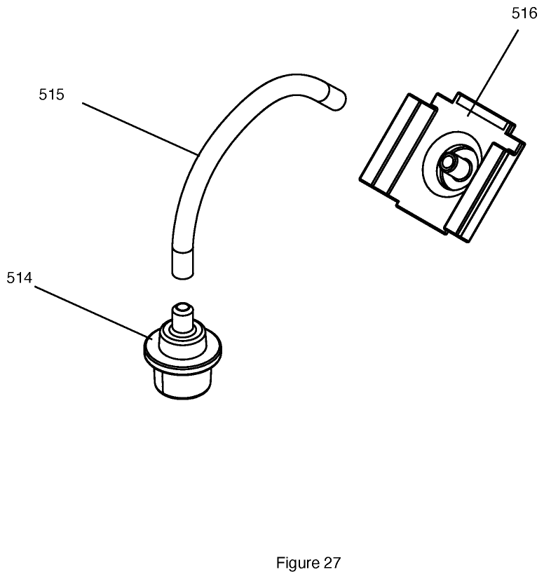

FIG. 27 shows an expanded view of the hose assembly, which is comprised of a fluid entry part 514 which when the device is fitted to a can, couples with the fluid exit pipe of the aerosol can. There is a hose 515, which transports the fluid to a fluid exit part 516. The fluid exit part is designed to engage with the sprocket and ensure fluid is substantially directed through the sprocket radial holes when below the hole in the fluid exit part. The hose assembly passes within the multi part button axle assembly 506 shown in FIG. 26—this avoid the need to form a dedicated fluid pathway in the different parts of the multi part button axle assembly.

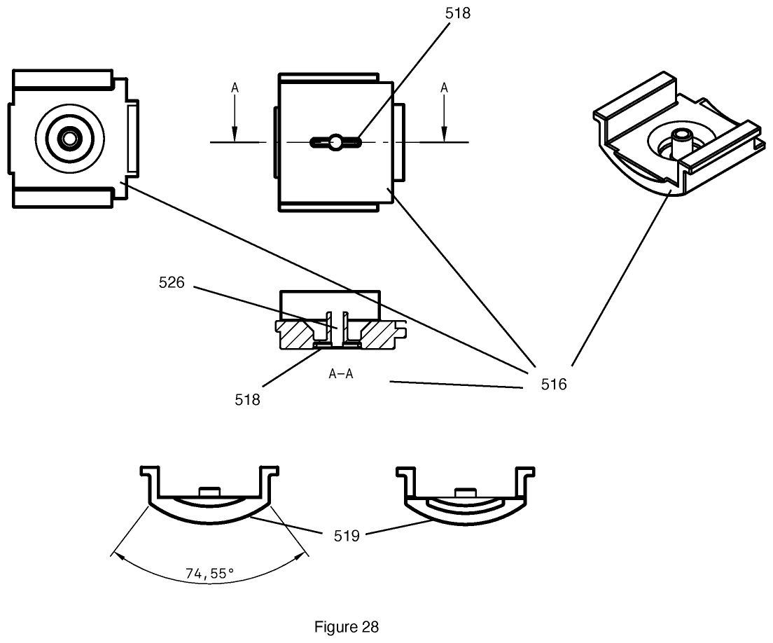

FIG. 28 shows the fluid exit part 516 alone from above, from below, in isometric view and in section view. Features on the part include a hose connector tube 520 with a hole 526 running through to bottom radial surface of the part and a slot 518 running partially across the bottom radial surface 519 of the part centred on the hole. This slot allows fluid to be distributed to both the holes in a radial hole pair and enables a smooth inner surface on the sprocket, which, by reducing undercuts, makes manufacture of the tooling for this part for production by plastic injection moulding easier. A smooth surface also makes production of this part by e.g. CNC machining easier as the features that can be machined inside a small hole are limited by the fact the ability to position the CNC machine's milling head is limited by the hole dimensions.

The angle of the arc described by the surface 519 is greater than the angle between pairs of radial holes in the sprocket (there are 10 pairs of radial holes through the sprocket, evenly spaced every 36 degrees). In this example, it is 74.55°

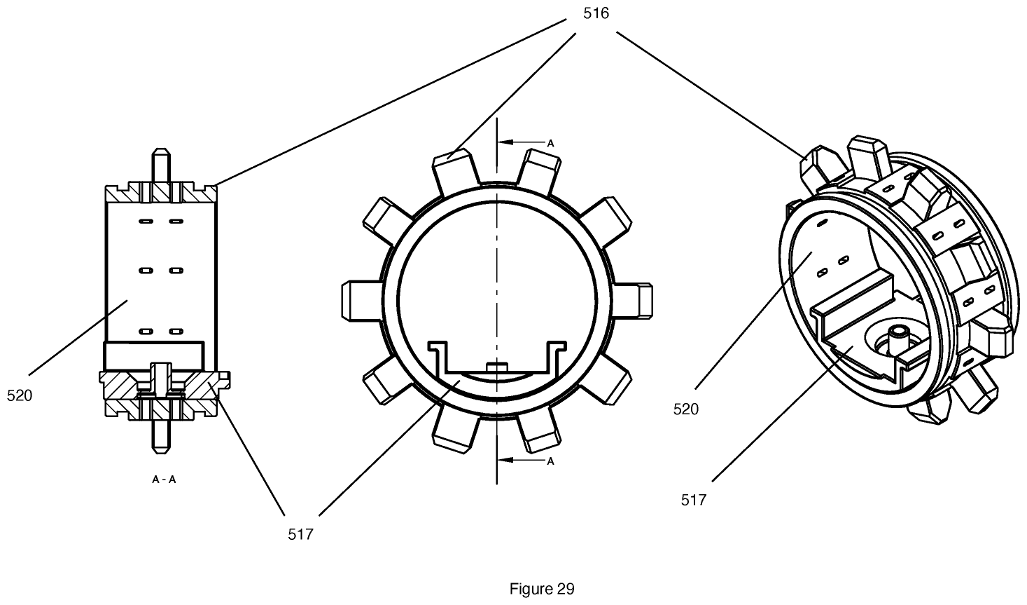

FIG. 29 shows just the fluid exit part 517 and the inner sprocket part 516 in the positional relationship they are to each other as when the device is fully assembled. The radius of the radial surface of the fluid exit (519 indicated in FIG. 28) part matches the radius of the inner surface of the sprocket part 520. This slight downward pressure excerpted by the user when the device is in use, is concentrated through the fluid exit part and the inner surface of the sprocket under that part is sufficient to help prevent or minimise fluid escaping between the surfaces and out of the side of the axle of the device and thus helps ensure the fluid exits through the radial sprocket holes.

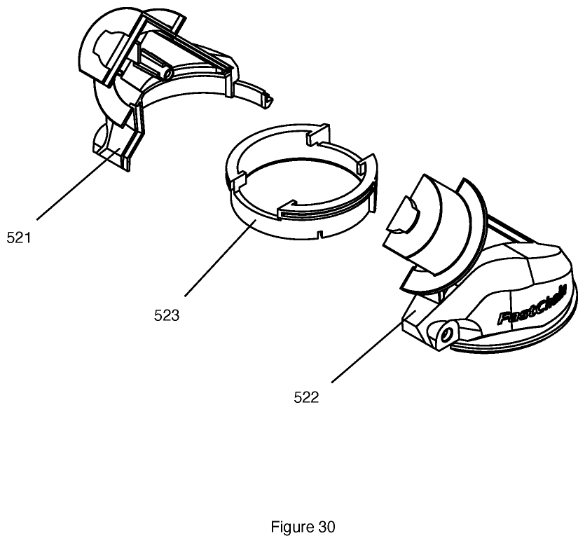

FIG. 30 shows parts for a sixth embodiment of the device, where the main cap is plastic injection moulded in two halves 521 and 522 and the sprocket axle feature is a solid structure integrated with these two halves. The friction fit sleeve for fitting the device to an aerosol can is moulded as a separate part 523 with a geometry ensuring it is retained in a fixed position between the two halves when assembled. In this embodiment there is a single screw boss for fixing the two parts together and sonic welding may be used during assembly to weld the halves together. The final assembly includes additional parts.

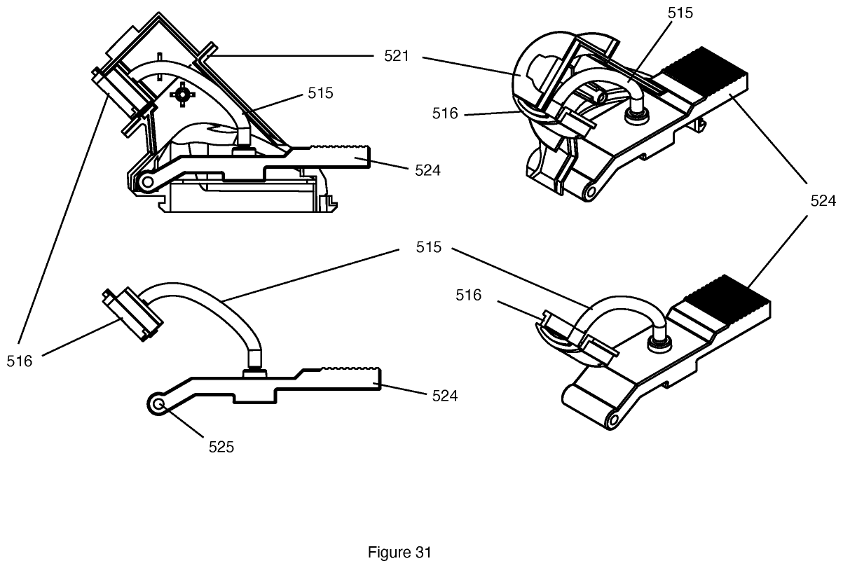

FIG. 31 shows the button and hose assembly of the sixth embodiment in position relative to one half of the main cap and also independently. It can be seen in this embodiment the button 524 can move independently of the sprocket axle which is now integrated with the main cap 521. The fluid exit part, 516 and hose 515 are the same as in the previous embodiment, however the button 524, has screw boss 525 which, as with the previous embodiment, enables it to be secured in place within the two halves of the main cap in a fashion similar to the button assembly of the fifth embodiment, the screws securing it in place also provide the pivot point for the movement of the button. In this embodiment, the hose provides a flexible coupling between the fluid entry and exit parts such that pressing the button causes the fluid entry part (integrated in the button), to move in relation to the fluid exit part but the two parts maintain their connection via the hose.

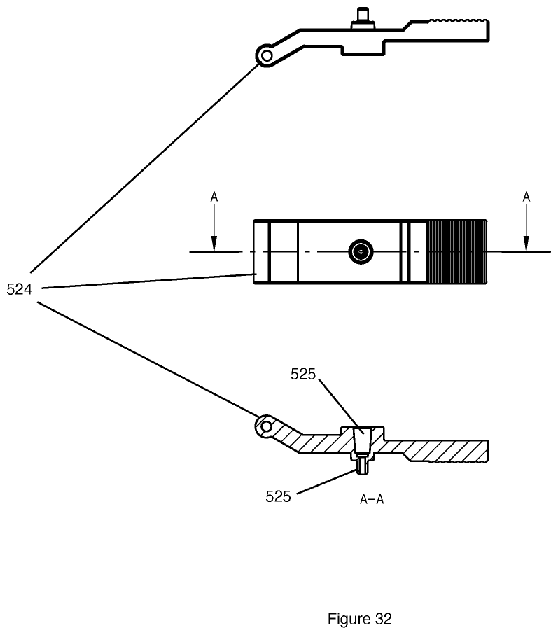

FIG. 32 shows the button 524 of the sixth embodiment only in side view, top view and cross-section view. In this embodiment the button also serves as the aerosol fluid entry part. The tapered tube 525 provides a friction fit coupling with the fluid exit pipe of an aerosol can and the hose connector tube is integrated with the top of the part.

The applicant hereby discloses in isolation each individual feature described herein and any combination of two or more such features, to the extent that such features or combinations are capable of being carried out based on the present specification as a whole in the light of the common general knowledge of a person skilled in the art, irrespective of whether such features or combinations of features solve any problems disclosed herein, and without limitation to the scope of the claims. The applicant indicates that aspects of the present invention may consist of any such individual feature or combination of features. In view of the foregoing description it will be evident to a person skilled in the art that various modifications may be made within the scope of the invention.

1. A sprocket assembly comprising:
a mount; and
a sprocket having an opening for receiving the mount such that the sprocket can rotate around the mount, the sprocket having a plurality of radially extending fluid pathways extending from the opening to a radially distal edge,
wherein the mount includes a manifold for fluid to be supplied to the sprocket, the manifold having a fluid exit channel towards the opening of the sprocket such that each radial pathway in the sprocket is in fluid communication with the manifold over only a part of a rotation of the sprocket about the mount.

2. An assembly according to claim 1, wherein the manifold includes a fluid receiving inlet.

3. An assembly according to claim 2, further comprising a fluid supply in communication with the inlet.

4. (canceled)

5. An assembly according to claim 1, wherein one or more of the radially extending fluid pathways widen towards the radially outermost end of the respective pathway.

6. An assembly according to claim 1, wherein the sprocket contains a plurality of teeth extending radially outward and defining valleys therebetween.

7. An assembly according to claim 6, wherein the teeth are shaped to engage with a bicycle chain.

8. An assembly according to claim 6, wherein the radially outermost end of a pathway is located at the radially innermost point of the valley.

9. An assembly according to claim 1, wherein the sprocket has an elastomeric coating on at least part of its outer surface.

10. An assembly according to claim 9, wherein the elastomeric coating is on one or more surfaces configured to contact, in use, a chain.

11. (canceled)

12. (canceled)

13. (canceled)

14. (canceled)

15. (canceled)

16. An assembly according to claim 1, wherein the sprockets has one or more walls extending radially outwards adjacent the sprocket teeth.

17. An assembly according to claim 16, wherein the sprockets has a pair of walls defining a channel in which the sprocket teeth are located.

18. An assembly according to claim 1, wherein the mount is an axle assembly about which the sprocket rotates.

19. An assembly according to claim 18, wherein the axle assembly is formed from two or more parts.

20. An assembly according to claim 2, further comprising a flexible supply hose for connection to the manifold inlet at one end and to a fluid supply at the other.

21. An assembly according to claim 20, wherein the mount is an axle assembly about which the sprocket rotates, the axle assembly being formed from two or more parts and, wherein the flexible supply hose passes within the multi part axle assembly.

22. A chain tool comprising:
a sprocket assembly according to claim 1; and a housing for retaining the mount of the sprocket assembly.

23. A chain tool according to claim 22, further comprising a handle by which the tool can be operated one handed.

24. A chain tool according to claim 22, further comprising a source of pressurised fluid.

25. A chain tool according to claim 24, further comprising an actuating button to operate the source of pressurised fluid.

26. (canceled)

27. A chain tool according to claim 22, further comprising an inlet port in fluid communication with the manifold for receiving an aerosol containing fluid to be supplied, wherein the port is angled relative to the axis of rotation of the sprocket.

28. (canceled)

29. (canceled)
